(19) United States
(12) Patent Application Publication
(10) Pub. No.: US 2005/0031488 A1
(43) Pub. Date: Feb. 10, 2005

(54) Sample array test slide with suspended membrane

(76) Inventors: Hui Ge, Gaithersburg, MD (US); Gregory A. Prince, Potomac, MD (US); Peter C. Shin, Bethesda, MD (US)

Correspondence Address: COOLEY GODWARD LLP;ATTN: PATENT GROUP, 11951 FREEDOM DRIVE, SUITE 1700, ONE FREEDOM SQUARE- RESTON TOWN CENTER, RESTON, VA, 20190-5061, US

(21) Appl. No.: 10/634,921

(22) Filed: Aug. 6, 2003

(51) Int. Cl. G01N 31/22

(52) U.S. Cl. 422/57

(57) ABSTRACT

A sample array test slide includes a support frame with an aperture and a membrane suspended from the support frame across the aperture. An array of test samples is bound to the membrane. Optionally a second membrane is suspended from the support frame across the aperture.

### BACKGROUND

The invention relates generally to equipment for biochemical testing, and in particular to sample array test slides.

Test slides are commonly used to immobilize target samples during analytical testing. Conventional test slides often consist of a solid substrate that is coated with a material, to which the target samples are bound. For example, slides for testing protein-protein interactions may consist of a glass substrate coated with a thin layer of nitrocellulose. An array of protein target samples is deposited on, and binds to, the nitrocellulose. The nitrocellulose may be coupled to the glass substrate with an adhesive layer deposited between the nitrocellulose and the glass substrate, or the nitrocellulose may be chemically modified to adhere directly to the glass. In test slides of this configuration, the underlying adhesive or the chemical modifications to the nitrocellulose can compromise the binding of the target samples to the nitrocellulose. The test results may be negatively influenced by the adhesive chemicals and/or by the compromised binding of the target samples to the nitrocellulose.

There is therefore a need for a sample array test slide that does not have these shortcomings.

### SUMMARY OF THE INVENTION

The disclosed sample array test slide and method of its manufacture overcome the shortcomings of conventional test slide configurations. The slide includes a support frame containing an aperture across which a membrane of desired material (such as nitrocellulose) is suspended. The portion of the membrane suspended over the aperture provides a location upon which an array of target samples may be deposited and bound or immobilized for the purpose of conducting analytical tests.

These and other aspects of the invention will become apparent from the following drawings and description.

### BRIEF DESCRIPTION OF THE DRAWINGS

The invention is described with reference to the following drawings. In the drawings, like reference numbers indicate similar elements.

FIG. 1 is a top plan view of one embodiment of a sample array test slide embodying the principles of the invention.

FIG. 2 is a cross-sectional view of the sample array test slide of FIG. 1 taken along the line 2-2 of FIG. 1.

FIG. 3 is a top plan view of a sheet of membrane material on which multiple arrays of target samples are deposited.

FIG. 4 is a cross-sectional view of a sample array test slide that illustrates one technique for mounting the membrane to the support frame.

FIG. 5 is a cross-sectional view of an alternative embodiment of a sample array test slide that includes a second suspended membrane.

FIG. 6 is a cross-sectional view of a sample array test slide that illustrates an alternative technique for mounting the membrane to the support frame.

### DETAILED DESCRIPTION

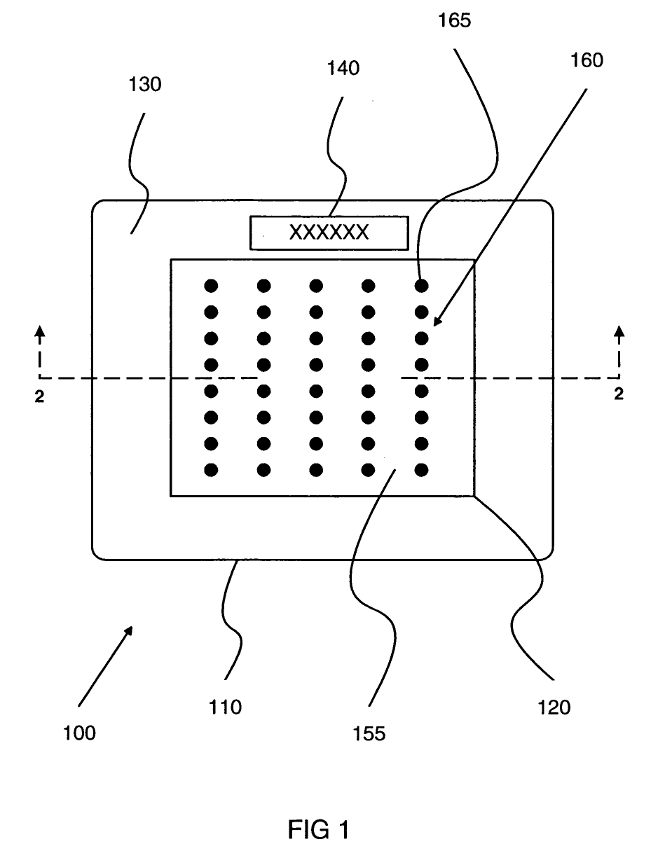

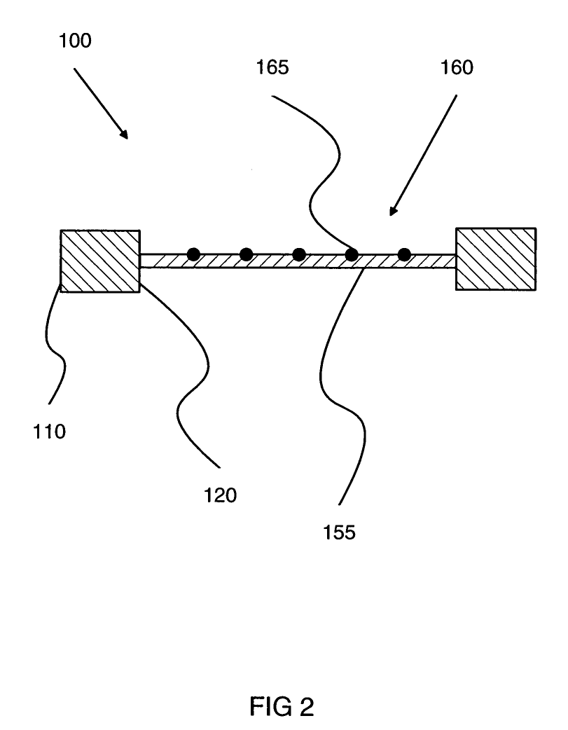

Several embodiments of a sample array test slide incorporating the principles of the invention are shown in FIGS. 1-6. A first embodiment of a sample array test slide 100 is illustrated schematically in FIGS. 1 and 2. Test slide 100 includes a support frame 110 and a membrane 155. Support frame 110 includes a central opening or aperture 120 across which membrane 155 is suspended. An array 160 of target samples 165 is disposed on membrane 155 and immobilized, or bound, to the membrane. Support frame 110 also includes a handling area 130 and, optionally, an identification label 140, which may identify the composition of target samples 165, their location within the array, or other information regarding the test procedures to be used on test slide 100.

Test slide 100 is suited for use with a variety of analytical tests, including, for example, the method of analyzing the binding characteristics of an array of target samples immobilized on a test slide disclosed in PCT Publication No. WO 00/54046 to Ge (“Ge”), the disclosure of which is incorporated herein in its entirety.

In the embodiment shown in FIGS. 1 and 2, membrane 155 is a unitary layer or sheet of relatively flexible and homogeneous material stretched across aperture 120 and fixed to support frame 110. Membrane 155 is fixed or mounted to support frame 110 such that it is sufficiently stable for use with the appropriate testing apparatus and method and can withstand forces applied to the slide, support frame, and/or membrane during handling, shipment, and use. In the illustrated embodiment, membrane 155 is rectangular in shape and has a thickness of between 0.1 and 0.5 mm.

The material used to construct membrane 155 is selected primarily based on the composition of the target samples 165 to be bound thereon. Suitable membrane materials can include nitrocellulose, hydrophobic polyvinylidene difluoride (PVDF), and Nylon. Target samples can include proteins, protein fragments, peptides, antibodies, RNA and DNA. Appropriate combinations will be apparent to the artisan, but by way of example, nitrocellulose would be a preferred material for binding proteins or peptides, and PVDF would be acceptable but less preferred, whereas either nitrocellulose or Nylon would be suitable materials for binding DNA and/or RNA. A particularly suitable membrane is pure nitrocellulose 0.2 to 0.3 mm thick with a nominal pore size of 0.22 μm and a binding capacity of 75 to 150 μg/cm², commercially available from Schleicher & Schuell BioScience.

As shown in FIG. 1, target samples 165 are deposited onto membrane 155 in the form of a rectangular array 160. As noted above, target samples 165 may be proteins, protein fragments, peptides, antibodies, DNA, and/or RNA. Sample array 160 may contain any number of target samples 165, from one to a thousand or more, depending on the dimensions of the array, the size of the target samples, and the spacing between the samples. Typically the array will have more than twenty samples. The target samples within a given sample array 160 may all be composed of the same compound, or may be of different compounds.

Support frame 110 defines an area to which membrane 155 is mounted. In the embodiment shown in FIG. 1, support frame 110 is rectangular in shape with a length and width of between 25 and 75 mm and a thickness of between 1 and 3 mm. Aperture 120 is also rectangular in shape with a length and width of between 13 and 50 mm. Handling area 130 is defined by the region between the outer periphery of support frame 110 and the periphery of aperture 120. Handling area 130 provides a portion of the support frame by which slide 100 can be grasped and manipulated, manually or by automated handling equipment. Handling area also provides a space for disposing label 140. Label 140 can include an area for written markings, for notches or depressions in support frame 110, a bar code, a magnetic strip, or any other means of storing information such as information identifying the composition of target samples 165, their location within array 160, or other information regarding the test procedures.

Support frame 110 can be constructed from any suitable material, including polymers, polymer composites (such as fiberglass), fiberboard, or any other materials that provide the requisite structural properties for supporting the membrane, sustaining forces applied during handling and testing, etc. and that meet other requirements such as durability, resistance to chemicals used in testing, etc.

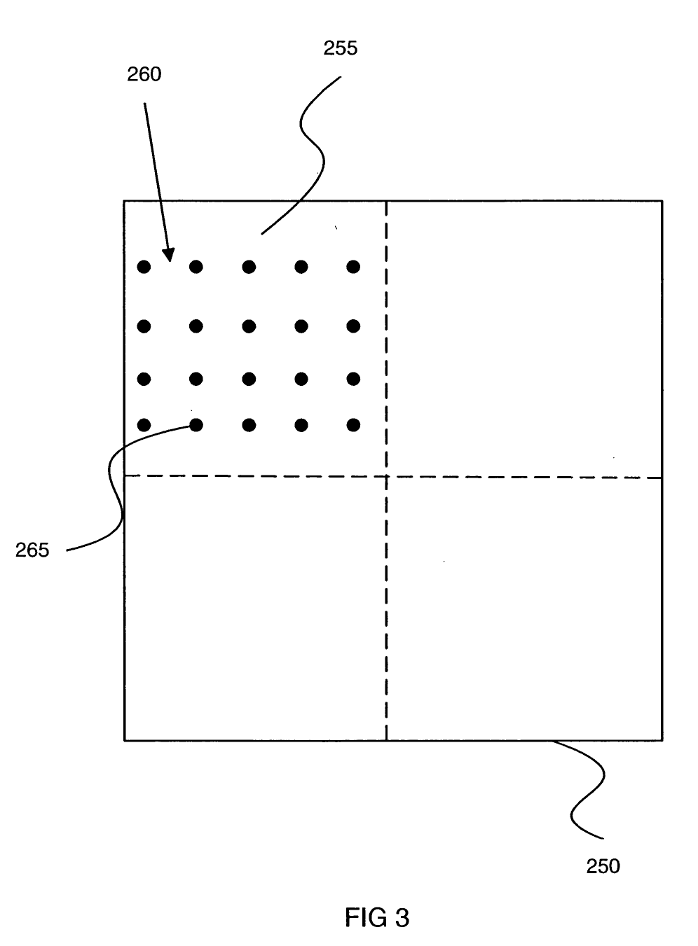

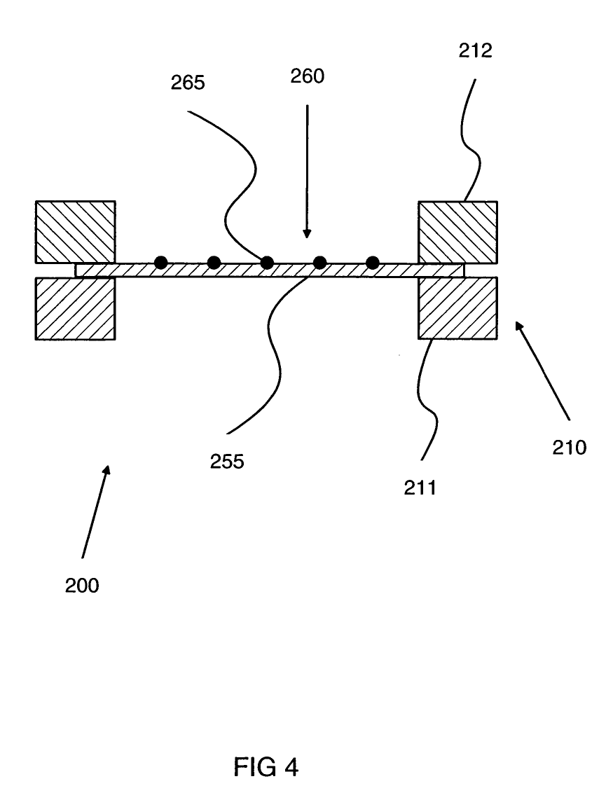

Taken together, FIGS. 3 and 4 illustrate one method of manufacturing a sample array test slide. FIG. 3 schematically illustrates a sheet 250 of material on which an array 260 of target samples 265 can be deposited along with other arrays (not shown). Sheet 250 can then be partitioned into smaller sections, including membrane 255, which can then be mounted to a support frame 210.

Membrane 255 can be mounted to support frame 210 by sandwiching edges of membrane 255 between the inner edges of top portion 211 and bottom portion 212 of support frame 210, as shown in FIG. 4. Membrane 255 can be adhered or otherwise attached at its margins to either or both of portions 211, 212. Portions 211 and 212 can similarly be joined together by any suitable technique.

Among the advantages of this method of manufacture are that sheet 250 can be supported on an underlying surface during the process of depositing array 260, thereby reducing stresses imposed by the deposition process that may compromise the integrity of sheet 250 if applied while sheet 250 is mounted in frame 210 and thus unsupported. Although shown as a larger sheet on which multiple arrays could be deposited, sheet 250 could also be sized for a single membrane 255 and have a single array applied thereto.

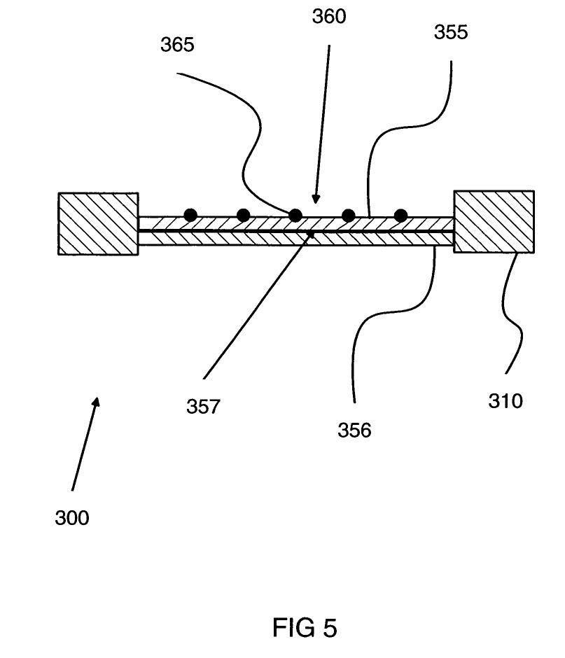

Alternatively, the array of target samples may be deposited onto the membrane after the test slide has been fully assembled. Since it may not be possible to support the membrane when using this manufacturing method, it may be desirable to increase the strength of the membrane. This can be accomplished in several ways, including using thicker material for the membrane, backing the membrane with another, reinforcing or supporting sheet or membrane, or potentially mixing a stronger material into the membrane material. FIG. 5 schematically illustrates a cross-sectional view of an alternative embodiment of a sample array test slide 300 that includes both a primary membrane 355 and a separate support membrane 356. Support membrane 356 is disposed adjacent the lower side of primary membrane 355. An array 360 of target samples 365 is disposed and immobilized on the upper side of primary membrane 355.

Support membrane 356 can be formed from a material different than that of primary membrane 355 (i.e. other than, e.g., nitrocellulose, PVDF, or Nylon). In the illustrated embodiment, support membrane 356 is formed from polypropylene or a similar polymer. Support membrane 356 is rectangular in shape, preferably matching or exceeding the area of the primary membrane 355. The thickness of support membrane 356 is between 0.2 and 1 mm, and can vary as a function of the material selection.

Support membrane 356 can be bonded to primary membrane 355 to form a single, composite membrane structure 357 prior to being mounted on support frame 310. Alternatively, primary membrane 355 and support membrane 356 can be individually mounted on support frame 310 without any permanent bond therebetween.

While particular, illustrative embodiments of the invention have been described, numerous variations and modifications exist that would not depart from the scope of the invention. For example, the membrane can be of any shape, size, or thickness. The membrane may also be formed with a non-homogeneous surface to allow for channels or wells in which target samples 165 may be immobilized. Similarly, although the membrane as described above is formed from nitrocellulose, PVDF, or Nylon, the scope of the invention also includes other materials suitable to bind or immobilize any selected target sample, including proteins, protein fragments, peptides, antibodies, DNA, and RNA.

Although the array of target samples is described above as being rectangular, it may be of any geometric shape. Moreover, the scope of the invention includes both micro- and macroarrays, or any combination thereof. A sample array test requires microscope evaluation of the target samples, whereas a macroarray does not. As such, the size of each target sample 165 may range from 0.01 mm to 5 mm.

Although the support frame and the aperture are described above as being rectangular in shape, they may be of any geometric shape and size. Moreover, the shape of the aperture need not match that of the support frame or the membrane. Similarly, those materials listed above do not limit the material from which the support frame is constructed.

Although the membrane is shown as covering the entire aperture, it need not do so. For example the membrane could be narrower than the width of the aperture, while spanning the length of the aperture and thus being suspended only by its ends, and not its sides, from the support frame.

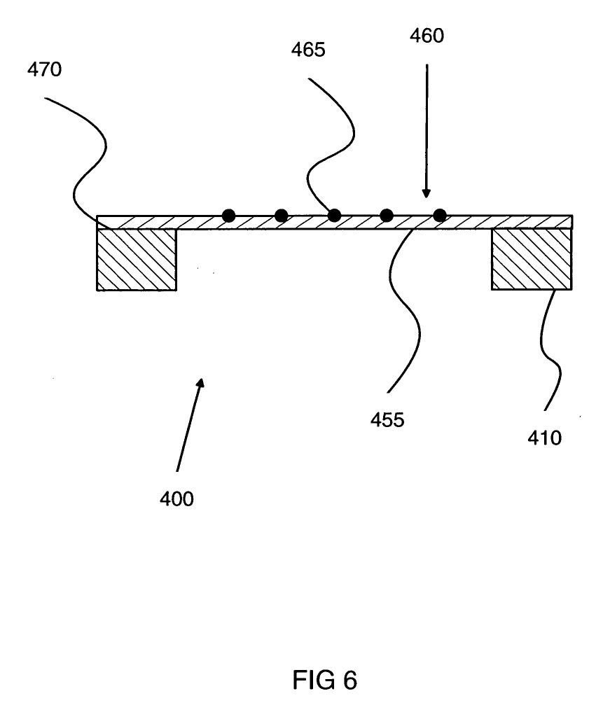

Although the membrane is described above as being mounted between two opposing sections of the support frame, the membrane may be mounted by any form of mechanical fastening, chemical bonding, and the like. As an example, FIG. 6 illustrates an embodiment of a sample array test slide 400 in which a membrane 455 is mounted on the top edges of support frame 410 and bonded with an adhesive layer 470.

Although the composite membrane 357 as described above includes two layers of dissimilar materials, it may be formed from more than two layers. Moreover, the composite membrane 357 may be a non-homogenous structure allowing for additional material to be included or removed from certain locations as required, for example in the form of a woven or non-woven mesh, or as individual strips, strands, or fibers.

Although the primary purpose of including a support membrane is to provide support for the primary membrane, the addition of additional membrane layers may be included to enhance all aspects of the performance of the test slide. For example, additional membrane layers may be added to improve resistance to heat, prevent over exposure to chemicals, or filter undesired radiation wavelengths.

### CONCLUSION

While various embodiments of the invention have been described above, it should be understood that they have been presented by way of example only, and not limitation. Thus, the breadth and scope of the invention should not be limited by any of the above-described embodiments, but should be defined only in accordance with the following claims and their equivalents.

The previous description of the embodiments is provided to enable any person skilled in the art to make or use the invention. While the invention has been particularly shown and described with reference to embodiments thereof, it will be understood by those skilled in the art that various changes in form and details may be made therein without departing from the spirit and scope of the invention.

1. A sample array test slide comprising:
a support frame having an aperture therein;
a membrane suspended across said opening, said membrane being formed of a material to which can bind a target sample selected from the group consisting of protein, protein fragments, peptides, antibodies, RNA, and DNA.

2. The sample array test slide of claim 1 wherein said membrane is formed of a material selected from the group consisting of nitrocellulose, PVDF, and Nylon.

3. The sample array test slide of claim 2 wherein said membrane consists essentially of nitrocellulose.

4. The sample array test slide of claim 2 wherein said membrane includes a support layer formed of a second material other than nitrocellulose, PVDF, or Nylon.

5. The sample array test slide of claim 4 wherein said second material is polypropylene.

6. The sample array test slide of claim 1 wherein said membrane is a first membrane and further comprising a second membrane suspended across said opening in supporting contact with said first membrane.

7. The sample array test slide of claim 6 wherein said second membrane is formed from a polymer.

8. The sample array test slide of claim 7 wherein said polymer is polypropylene.

9. The sample array test slide of claim 1 further including an array of target samples selected from the group consisting of protein, protein fragments, peptides, antibodies, RNA, and DNA and bound to said membrane.

10. The sample array test slide of claim 9 wherein said array includes target samples containing a plurality of different compounds.

11. The sample array test slide of claim 10 wherein said plurality of different compounds includes at least twenty different compounds.

12. The sample array test slide of claim 10 further including an identification label disposed on said support frame, said identification label uniquely identifying said plurality of different compounds, their location within said array, or other pertinent information.

13. The sample array test slide of claim 1 further including an identification label disposed on said support frame.

14. The sample array test slide of claim 1 wherein said support frame is formed from a polymer.

15. The sample array test slide of claim 1 wherein said membrane has a thickness of between 0.1 and 0.5 mm.

16. The sample array test slide of claim 6 wherein said first membrane has a thickness of between 0.1 and 0.5 mm and said second membrane has a thickness of between 0.2 to 1 mm.

17. A method of preparing a sample array test slide comprising:
depositing on a membrane an array of target samples of compounds selected from the group consisting of protein, protein fragments, peptides, antibodies, RNA, and DNA;
disposing the membrane to be suspended from a peripheral support frame.

18. The method of claim 17 further comprising, prior to said disposing the membrane, trimming the membrane to fit the support frame.

19. The method of claim 17 wherein said depositing include depositing target samples of a plurality of different compounds.

20. The method of claim 17 wherein the membrane is formed of a material selected from the group consisting of nitrocellulose, PVDF, and Nylon.

21. The method of claim 20 wherein the membrane consists essentially of nitrocellulose.

22. The method of claim 17 wherein said depositing includes depositing said target samples in a rectangular array.

23. The method of claim 17 wherein said depositing includes depositing at least twenty target samples.

24. The method of claim 17 further comprising disposing a support membrane to be suspended from the peripheral support frame.

25. The method of claim 24 wherein the support membrane is formed from a polymer.

26. The method of claim 25 wherein the polymer is polypropylene.

27. The method of claim 24 further comprising contacting the membrane with the support membrane prior to said disposing the membrane.

28. The method of claim 17 wherein said depositing is performed before said disposing.

29. The method of claim 17 wherein said disposing is performed before said depositing.

30. A sample array test slide consisting essentially of:
a support frame having an aperture therethrough;
a membrane mounted to said support frame and suspended in said opening; and
an array of target samples bound to said membrane, said target samples formed of a plurality of different materials selected from the group consisting of proteins, protein fragments, peptides, antibodies, RNA, and DNA.

31. The sample array test slide of claim 30 wherein said membrane is formed of a material selected from the group consisting of nitrocellulose, PVDF, and Nylon.

32. The sample array test slide of claim 31 wherein said membrane consists essentially of nitrocellulose.

33. The sample array test slide of claim 31 wherein said membrane includes a support layer formed of a second material other than nitrocellulose, PVDF, or Nylon.

34. The sample array test slide of claim 33 wherein said second material is polypropylene.

35. The sample array test slide of claim 30 wherein said plurality of different materials includes at least twenty different materials.

36. A sample array test slide consisting essentially of:
a support frame having an aperture therethrough;
a test membrane mounted to said support frame and suspended in said opening;
a support membrane mounted to said support frame, suspended in said opening, and disposed in supporting contact with said test membrane; and
an array of target samples bound to said membrane, said samples formed of a plurality of different compounds selected from the group consisting of proteins, protein fragments, peptides, antibodies, RNA, and DNA.

37. The sample array test slide of claim 36 wherein said test membrane is formed of a material selected from the group consisting of nitrocellulose, PVDF, and Nylon.

38. The sample array test slide of claim 37 wherein said test membrane consists essentially of nitrocellulose.

39. The sample array test slide of claim 37 wherein said test membrane includes a support layer formed of a second material other than nitrocellulose, PVDF, or Nylon.

40. The sample array test slide of claim 39 wherein said second material is polypropylene.

41. The sample array test slide of claim 36 wherein said support membrane is formed from a polymer.

42. The sample array test slide of claim 41 wherein said polymer is polypropylene.

43. The sample array test slide of claim 36 wherein said plurality of different materials includes at least twenty different compounds.
